(19) United States
(12) Patent Application Publication
(10) Pub. No.: US 2007/0264993 A1
(43) Pub. Date: Nov. 15, 2007

(54) METHOD, APPARATUS AND ARTICLE FOR OPINION POLLING

(76) Inventor: Bryan G. Hughes, Vancouver (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 11/538,589

(22) Filed: Oct. 4, 2006

Related U.S. Application Data
(60) Provisional application No. 60/723,466, filed on Oct. 4, 2005.

(51) Int. Cl. H04Q 7/20

(52) U.S. Cl. 455/422.1

(57) ABSTRACT

Polling questions and a fixed set of answers are provided in a first form of media with an expected geographic distribution. A standard graphical user interface with a predefined set of user-selectable icons is provided in a second form of media such as a bidirectional wireless communications device such as a cellular phone. The user interface allows a user to respond to polling questions with a simplified entry such as by scrolling to one of the icons and selecting. Response to a polling question may be confirmed and an incentive may be provided such as a cash or service reward or results of the poll.

### CROSS-REFERENCE TO RELATED APPLICATION

This application claims the benefit under 35 U.S.C. § 119(e) of U.S. Provisional Patent Application No. 60/723,466, filed Oct. 4, 2005.

### BACKGROUND OF THE INVENTION

1. Field of the Invention

This disclosure generally relates to opinion polling or surveying, and more particularly relates to opinion polling via two difference communications mediums.

2. Description of the Related Art

An ever-increasing number opinion polls or surveys are being conducted. Such polling or surveying is used to capture a variety of information. For example, some polls attempt to capture voter or likely voter preference for a candidate and/or issue that may appear on a ballot. Other polls may attempt to capture consumer preferences or dislikes with respect to goods or services, or even the health of the economy. Some of these polls may additionally, or alternatively, be used to inform the polling subject's point-of-view. In such polls, the queries or questions, as well as the answers are selected so as to influence the polling subject. Such polls may, for example, raise an issue and/or present a solution that would not otherwise have been appreciated by the polling subject. Many of these polls are conducted via telephone, with a poll taker calling a respondent, and orally posing a series of questions and responses. Other of these polls are conducted face-to-face, for example with respondents selected at a public location such as a shopping mall. The poll takers may orally present questions and responses orally, or with a written form. The respondents may, or may not, be taken to a private location.

Still further polls are employed to encourage consumer interaction. For example, such polls may encourage interaction of a consumer with a good or service. For instance, a number of current television programs allow viewers to register a preference for a performer or contestant. Such interaction may not only increase the number of viewers watching the program by inviting the active participation of the viewers, but may also provide evidence of high ratings as well as evidence that the viewers are actively involved in the program rather than simply having their television sets tuned to a particular channel. Such polling is typically associated with a toll number, each call generating revenue for the program producer.

In such programs, each of the selections (e.g., performer, participant, question) is associated with a respective telephone number that the viewer may call to enter a vote for the selection. Alternatively, the viewer may be provided with a single call in number and may enter a six digit identifier to identify the desired selection. Such call in schemes are rather cumbersome, requiring the viewer to temporarily remember a telephone number and/or lengthy identifier, and to make a large number of keystrokes to identify the desired selection. Any reduces the participation rate, which may have adverse results on the quality of the polling and/or on revenue streams that may be based on such polling. Such an approach is also not particularly suited for media other than television, since television viewing is typically limited to fixed locations.

An improved approach to polling or surveying is desirable.

### BRIEF SUMMARY OF THE INVENTION

A method of polling employing bidirectional wireless communications devices operating in a bidirectional wireless communications medium and at least one other media, comprises: presenting a series of queries in at least a first medium different from the bidirectional wireless communications medium; receiving responses to various ones of the queries at least partially via the bidirectional wireless communications medium; and computationally associating the received responses with specific ones of the queries.

A polling system, comprises: communications means for receiving responses originated from a plurality of bidirectional wireless communications medium to various ones of a plurality of queries posed in a first medium different from a bidirectional wireless communications medium employed by the bidirectional wireless communications devices; and computational means for computationally associating the received responses with specific ones of the queries.

A processor-readable medium stores instructions to cause a processor to implement a user interface for polling on a bidirectional wireless communications device, by: in response to repeated user inputs over time of a first user input type, repeatedly displaying a set of icons on a display of the bidirectional wireless communications device, a quantity of icons in the set of icons being equal to a quantity of responses in each of a plurality of sets of responses to a respective query of a plurality of queries and all of the icons in the set of icons being displayed each time, the queries and the sets of responses posed in a form of media different from a bidirectional wireless form of media employed by the bidirectional wireless communications device, and the icons being displayed without displaying of the queries or specific ones of the responses on the display of the bidirectional wireless communications device, the icons being user identifiable and user selectable icons; determining whether a user input is an icon identifying input or an icon selection input; and transmitting a wireless message from the bidirectional wireless communications device that includes an indication of the selected one of the set of icons in response to a determination that that the user input is the icon selection input.

The approached described herein may produce higher participation rates and/or increased accuracy and/or confidence in polling or survey results. Such may also encourage increased sales of a first media, for example a paper media such as periodicals, tickets, schedules, forms and/or programs, while also increasing usage of a second media, for example short service messaging (SMS) and/or text messaging.

### BRIEF DESCRIPTION OF THE SEVERAL VIEWS OF THE DRAWING(S)

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic view showing a first polling system covering a first geographic area and a second polling system covering two geographic areas, according to an illustrated embodiment, each of the polling systems including a polling computing system, a wireless bidirectional communications system or network, and at least one form of media other than a wireless bidirectional communications medium employed by the wireless bidirectional communications system or network.

FIG. 2 is a functional block diagram of a polling computing system according to an illustrated embodiment.

FIG. 3 is a front view of a wireless communications device in the form of a cellular telephone, according to an illustrated embodiment.

FIG. 4 is a schematic view of a display of the wireless communications device of FIG. 3, showing an exemplary confirmation message, according to an illustrated embodiment.

FIG. 5 is a schematic view of the display of the wireless communications device of FIG. 3, showing an exemplary congratulatory message according to an illustrated embodiment.

FIG. 6 is a schematic view of the display of the wireless communications device of FIG. 3, showing a further exemplary congratulatory message according to an illustrated embodiment.

FIG. 7 is a schematic view of the display of the wireless communications device of FIG. 3, showing an exemplary polling results message according to an illustrated embodiment.

FIG. 8 is a schematic view of the display of the wireless communications device of FIG. 3, showing an exemplary respondent demographic query message according to an illustrated embodiment.

FIG. 9 is an isometric view of a form of media other than the bidirectional wireless communications medium, in the form of a periodical such as a newspaper or magazine according to an illustrated embodiment.

FIG. 10 is a front view of a form of media other than the bidirectional wireless communications medium, in the form of a ticket or pass according to an illustrated embodiment.

FIG. 11 is a front view of a form of media other than the bidirectional wireless communications medium, in the form of a score card according to an illustrated embodiment.

FIG. 12 is a front view of a form of media other than the bidirectional wireless communications medium, in the form of a racing form according to an illustrated embodiment.

FIG. 13 is an isometric view a form of media other than the bidirectional wireless communications medium, in the form of a program or schedule according to an illustrated embodiment.

FIGS. 14A and 14B are a high level flow diagram illustrating the operation and acts of a publisher, polling computing system, bidirectional wireless communications device and user of the bidirectional wireless communications device, according to one illustrated embodiment.

FIG. 15 is a flow diagram illustrating a method of processing responses according to one illustrated embodiment.

FIG. 16 is a flow diagram illustrating a method of processing responses according to one illustrated embodiment.

FIG. 17 is a flow diagram illustrating a method of processing responses according to one illustrated embodiment.

FIG. 18 is a flow diagram illustrating a method of processing responses according to one illustrated embodiment.

### DETAILED DESCRIPTION OF THE INVENTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with wireless communications devices, wireless communications systems, for example cellular phone systems, and computing systems have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

The headings provided herein are for convenience only and do not interpret the scope or meaning of the embodiments.

Overview of System

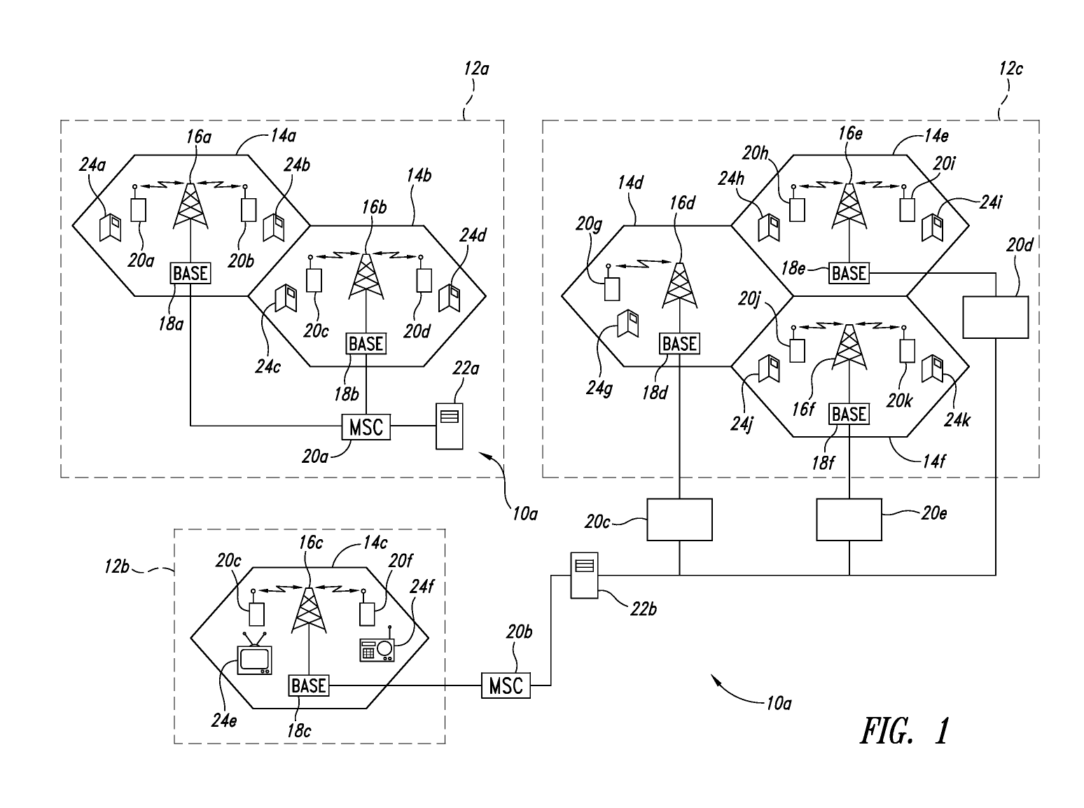

FIG. 1 shows a first surveying or polling system 10a covering a first geographic area illustrated by broken line box 12a, and a second surveying or polling system 10b covering a second geographic area illustrated by broken line box 12b, and a third geographic area illustrated by broken line box 12c. The polling systems 10a, 10b may employ or interface with one or more bidirectional wireless communications system, such as a cellular phone system for receiving responses or answers to polling queries or questions.

As illustrated in FIG. 1, the first geographic area 12a may be divided or partitioned into a number of cells 14a, 14b associated with a wireless communications system or network, for example a cellular phone system or network. Each of the cells 14a, 14b may be associated with a respective cellular antenna 16a, 16b and/or base station 18a, 18b. The cellular antennas 16a, 16b and base stations 18a, 18b provide wireless communications with a plurality of wireless communications devices, for example cellular phones 20a-20d as is generally known in the art. In addition to the cellular antennas 16a, 16b and/or base stations 18a, 18b, the wireless communications system may include one or more mobile switching centers 20a, that may couple the base stations 18a, 18b to one or more wireless or wired networks, for example a plain old telephone system (POTS) network. Such networks may provide bidirectional communications between the cellular phones 20a-20d and a first polling computing system 22a.

Similarly, the second geographic area 10b may be divided or partitioned into one or more cells 14c associated with a wireless communications system or network, for example a cellular phone system or network. Each of the cells 14c may be associated with a respective cellular antenna 16c and/or base station 18c. The cellular antenna 16c and base station 18c provide wireless communications with a plurality of wireless communications devices, for example personal digital assistants (PDAs) 20e, 20f capable of providing wireless email, wireless Internet or other wireless services. In addition to the cellular antennas 16c and/or base stations 18c, the wireless communications system or network may include one or more mobile switching centers 20b, that may couple the base stations 18c to one or more wireless or wired networks. Such networks may provide bidirectional communications between the PDAs 20e-20f and a second polling computing system 22b.

Similarly, the third geographic area may be divided or partitioned into a number of cells 14d-14f associated with a wireless communication system or network, for example a cellular phone system or network. Each of the cells 14d-14f may be associated with a respective cellular antenna 16d-16f and/or base station 18d-18f. The cellular antennas 16d-16f and/or base stations 18d-18f provide wireless communications with a plurality of wireless communications devices 20g-20k. In addition to the cellular antennas 16d-16f and/or base stations 18d-18f, the wireless communications system or network may include one or more mobile switching centers 20c-20e, that may couple the base stations 18d-18f to one or more wireless or wired networks. Such networks may provide bidirectional communications between the wireless communications devices 20g-20k and a second polling computing system 22b.

One or more of the wireless communications devices (referenced collectively as 20) are operated by users who have access to a form of media different than the bidirectional wireless communications medium employed by the wireless communications devices 20. As explained in more detail below, the media may, for example, take the form of print media 24a-24d, 24g-24k, for instance newspapers, magazines, tickets, passes, programs, score cards, schedules, betting forms and/or billboards, and/or take the form of wireless media, for instance television 24e or radio 24f.

Polling Computing System

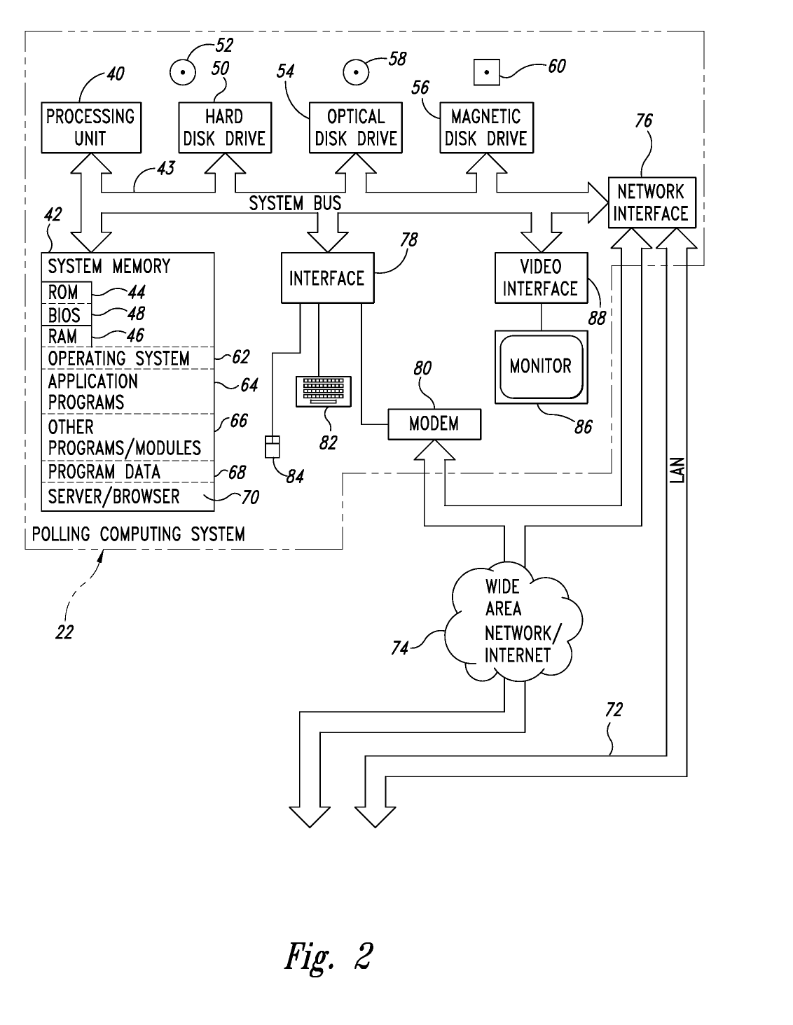

FIG. 2 and the following discussion provides a brief and general description of a suitable computing environment in which embodiments of the invention can be implemented, particularly those of FIG. 1. Although not required, embodiments will be described in the general context of computer-executable instructions, such as program application modules, objects or macros being executed by a computer. Those skilled in the relevant art will appreciate that the invention can be practiced with other computing system configurations, including hand-held devices, multiprocessor systems, microprocessor-based or programmable consumer electronics, personal computers (“PCs”), network PCs, mini-computers, mainframe computers, and the like. The embodiments can be practiced in distributed computing environments where tasks or modules are performed by remote processing devices, which are linked through a communications network. In a distributed computing environment, program modules may be located in both local and remote memory storage devices.

The subject matter of FIG. 2 and the following discussion may be generally or specifically relevant to computing systems suitable for use as any one or more of the polling computing systems 22a, 22b (generically referred to as 22). In the interest of brevity, only significant differences in hardware and operation of the various computing systems will be set out and discussed separately.

Referring to FIG. 2, a polling computing system 22 includes a processing unit 40, a system memory 42, and a system bus 43 that couples various system components including the system memory 42 to the processing unit 40. The polling computing system 22 will at times be referred to in the singular herein, but this is not intended to limit the application to a single polling computing system 22 since in typical embodiments, there will be more than one polling computing system 22 or other device involved. The polling system 10 may employ other computing systems, such as convention and personal computers, where the size or scale of the system allows. The processing unit 40 may be any logic processing unit, such as one or more central processing units (“CPUs”), digital signal processors (“DSPs”), application-specific integrated circuits (“ASICs”), etc. Unless described otherwise, the construction and operation of the various blocks shown in FIG. 2 are of conventional design. As a result, such blocks need not be described in further detail herein, as they will be understood by those skilled in the relevant art.

The system bus 43 can employ any known bus structures or architectures, including a memory bus with memory controller, a peripheral bus, and a local bus. The system memory 42 includes read-only memory (“ROM”) 44 and random access memory (“RAM”) 46. A basic input/output system (“BIOS”) 48, which can form part of the ROM 44, contains basic routines that help transfer information between elements within the polling computing system 22, such as during startup.

The polling computing system 22 also includes a hard disk drive 50 for reading from and writing to a hard disk 52, and an optical disk drive 54 and a magnetic disk drive 56 for reading from and writing to removable optical disks 58 and magnetic disks 60, respectively. The optical disk 58 can be read by a CD-ROM, while the magnetic disk 60 can be a magnetic floppy disk or diskette. The hard disk drive 50, optical disk drive 54 and magnetic disk drive 56 communicate with the processing unit 40 via the bus 43. The hard disk drive 50, optical disk drive 54 and magnetic disk drive 56 may include interfaces or controllers (not shown) coupled between such drives and the bus 43, as is known by those skilled in the relevant art. The drives 50, 54 and 56, and their associated computer-readable media, provide non-volatile storage of computer readable instructions, data structures, program modules and other data for the computing system 22. Although the depicted polling computing system 22 employs hard disk 52, optical disk 58 and magnetic disk 60, those skilled in the relevant art will appreciate that other types of computer-readable media that can store data accessible by a computer may be employed, such a magnetic cassettes, flash memory cards, digital video disks (“DVD”), Bernoulli cartridges, RAMs, ROMs, smart cards, etc.

Program modules can be stored in the system memory 42, such as an operating system 62, one or more application programs 64, other programs or modules 66 and program data 68. The system memory 42 may also include a networking application 70, for example a Web server application and/or Web client or browser application for permitting the polling computing system 22 to exchange data with sources via the Internet, corporate Intranets, or other networks as described below, as well as with other server applications on server computers such as those further discussed below. The networking application 70 in the depicted embodiment is markup language based, such as hypertext markup language (“HTML”), extensible markup language (“XML”) or wireless markup language (“WML”), and operates with markup language that use syntactically delimited characters added to the data of a document to represent the structure of the document. A number of Web server applications and Web client or browser applications are commercially available such those available from America Online and Microsoft of Redmond, Wash.

While shown in FIG. 2 as being stored in the system memory 42, the operating system 62, application program 64, and other programs/modules 66, program data 68 and networking application 70 can be stored on the hard disk 52 of the hard disk drive 50, the optical disk 58 of the optical disk drive 54 and/or the magnetic disk 60 of the magnetic disk drive 56.

The polling computing system 22 can operate in a networked environment using logical connections to one or more remote computers or networks, such as the bidirectional wireless communications clients 20. The polling computing system 22 is logically connected to one or more other polling computing systems 22 under any known method of permitting computers to communicate, such as through a local area network (“LAN”) 72, or a wide area network (“WAN”) including, for example, the Internet 74. Such networking environments are well known including wired and wireless enterprise-wide computer networks, intranets, extranets, and the Internet. Other embodiments include other types of communication networks such as telecommunications networks, cellular networks, paging networks, and other mobile networks. When used in a LAN networking environment, the polling computing system 22 is connected to the LAN 72 through an adapter or network interface 76 (communicative linked to the bus 43). When used in a WAN networking environment, the polling computing system 22 may include an interface 78 and modem 80 or other device, such as the network interface 76, for establishing communications over the WAN/Internet 74.

The modem 80 is shown in FIG. 2 as communicatively linked between the interface 78 and the WAN/Internet 74. In a networked environment, program modules, application programs, or data, or portions thereof, can be stored in the polling computing system 22 for provision to the networked computers. In one embodiment, the computing system 22 is communicatively linked through the LAN 72 or WAN/Internet 74 with TCP/IP middle layer network protocols; however, other similar network protocol layers are used in other embodiments, such as user datagram protocol (“UDP”). Those skilled in the relevant art will readily recognize that the network connections shown in FIG. 2 are only some examples of establishing communications links between computers, and other links may be used, including wireless links.

While in most instances the polling computing system 22 will operate automatically, an operator can enter commands and information into the polling computing system 22 through optional input devices, such as a keyboard 82, and a pointing device, such as a mouse 84. Other input devices can include a microphone, joystick, scanner, etc. These and other input devices are connected to the processing unit 40 through the interface 78, such as a serial port interface that couples to the bus 43, although other interfaces, such as a parallel port, a game port, or a wireless interface, or a universal serial bus (“USB”) can be used. A monitor 86 or other display device is coupled to the bus 43 via a video interface 88, such as a video adapter. The polling computing system 22 can include other output devices, such as speakers, printers, etc.

Bidirectional Wireless Communications Device

FIG. 3 shows a bidirectional wireless communications device (generically referred to as 20) according to one illustrated embodiment.

The bidirectional wireless communications device 20 may take a variety of forms, for example, a cellular phone, wireless enabled PDA and/or pager. The bidirectional wireless communications device 20 may employ short message service (SMS) messages and/or text messages or paging.

The bidirectional wireless communications device 20 may include a speaker 100 and a microphone 102, positioned on a housing 104 to allow a user to speak into the microphone while listening to the speaker. The bidirectional wireless communications device 20 may include one or more displays 106, for example a liquid crystal display (LCD). The display 106 typically has relatively small dimensions, for example two inch by two inch or smaller.

The bidirectional wireless communications device 20 may also includes a number of user actuable controls 108. The controls 108 may include keys of a standard keypad 110, each key corresponding to a respective one of the digits 0-9 and to two special symbols * and #, commonly found on keypads associated with telephones. The bidirectional wireless communications device 20 may also include an ON/OFF switch, button key 112.

The bidirectional wireless communications device 20 may further include one or more user input devices operable for identifying and/or selecting items or icons displayed on the display 106. For example, a scrolling mechanism such as joystick or rocker switch 114 may allow the user to scroll a cursor displayed in the display 106 to identify an item or icon. For example, the rocker switch 114 may toggle between two opposed directions, allowing the user to scroll a cursor in two orthogonal directions in the display 106. Alternatively, the rocker switch 114 may toggle in more than two opposed directions. For example, the rocker switch 114 may toggle forward, back, and left, right, allowing a user to scroll top, bottom, left, right, in the display 106, respectively. The rocker switch 114 may also be selectively actuable to select an item or icon indicated via the scrolling in the display 106. For example, the rocker switch 114 may be depressed to select an identified item or icon. Thus, the bidirectional wireless communications device 20 may advantageously employ two different types of user actions (e.g., scrolling versus clicking) to respectively identify an icon and select the icon.

The bidirectional wireless communications device 20 may further include additional keys 116a, 116 b, for example, operable to display menus. While the scrolling mechanism is illustrated and discussed as a joystick or rocker switch, the scrolling mechanism may take any of variety of other forms, including, for example, a set of two or more keys that bear a defined physical relationship to one another. For example, selection of the key bearing the legend “2” may move the cursor up in the display 106, while selection of the key bearing the legend “8” may move the cursor down. Likewise, selection of the key bearing the legend “4” may move the cursor left in the display 106, while selection of the key bearing the legend “6” may move the cursor right. Other keys, or key combinations are possible. Alternatively, scrolling may be implemented based on a duration of key depression or number of times a key is depressed in a given period (e.g. single versus double clicking).

FIG. 3 also shows a graphical user interface window 118, that advantageously allows a user to enter responses or answers to queries or questions in a simple, easy and intuitive manner. The graphical user interface includes a defined number of user selectable icons, represented in the illustrated embodiment as five user selectable icons 120a-120e. Other embodiments may employ a greater or lesser number of user selectable icons. The user selectable icons 120a-120e may each be associated with a respective identifier, for example a legend (e.g., 1-5) positioned proximate the respective user selectable icon 120a-120e. The identifiers map the user selectable icons 120a-120e to responses or answers to a query or question presented in another form of media, discussed more fully below.

The graphical user interface window 118 may be produced by software or firmware preloaded onto the wireless communications device. In this sense preloaded means that instructions for producing the graphical user interface window 118 are defined in the wireless communications device 20 before the query or question is posed, and in some embodiments before the query or question is composed or created. Thus, the number of user selectable icons 120a-120e is preferably consistent from query to query. This may require that queries or questions and corresponding responses or answers to be created or defined to fit the number of the user selectable icons 120a-120e provided in the defined graphical user interface window 118. Such an approach may advantageously enhance speed of operation of the wireless communications device 20 and/or reduce communication exchanges and/or associated charges (e.g., charges associated with SMS messages) over other embodiments that would download a graphical user interface window or an indication of the number of responses or answers each time a query or question is posed. Although in some embodiments, the instructions for producing the graphical user interface window 118 may be updated from time to time, such typically will occur at lower frequency than the provision of queries or questions. For example, while queries or questions may be posed on a daily basis, the instructions may be updated on a weekly, monthly or yearly basis.

As discussed above, the user may identify a desired one of the user selectable icons 120a-120e by scrolling. A visual indication of the currently identified icon may be provided by, for example, highlighting, marqueeing, flashing, changing colors, or otherwise emphasizing the identified one of the icons, for example, as illustrated by use selectable icon 120b in FIG. 3.

Selection of the identified one of the user selectable icons 120a-120e, may cause the wireless bidirectional communications device 20 to send an appropriate message to the polling computing system, for example a SMS message. The message may include an indication of the selected user selectable icon 120a-120e. Alternatively, or additionally, the message may be directed to one a number telephone numbers associated with respective ones of the responses or answers. Such may advantageously allow the polling computing system 22 to automatically tabulate and/or analyze the received responses or answers.

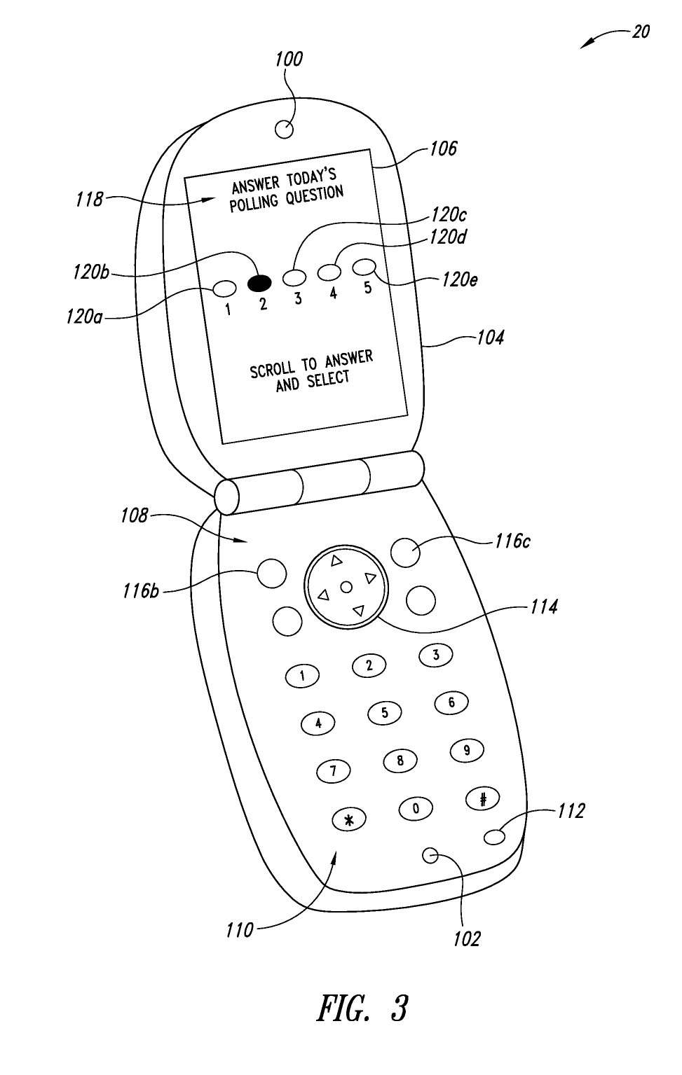

FIG. 4 shows the display 106 of the bidirectional wireless communications device 20 displaying a first confirmation message 130 to confirm receipt of a response or answer to the query or question, and to notify the user of entry into a prize drawing. The polling computing system 22 may automatically transmit the first confirmation message 130 to the wireless communications device 20 upon receipt of the response or answer to a query. Entry into a prize drawing or other incentive or reward may provide positive motivation for the individuals or users to respond to queries or questions. The polling computing system 22 or associated computing system may automatically perform entry into the drawing, as well as selection of winning entries and/or award of incentives or rewards. Incentives or rewards may take a variety of forms, including but not limited to: goods, services, value in money, time, or other forms of credit. For example, the incentive or reward may be in the form credit to the user's wireless communications account, for example credit for extra calling minutes or SMS messages. Also for example, the incentive or reward may be access to a restricted Website, or credit for ordering or downloading music, movies, books or other materials from such a Website. As a further example, the incentive or reward may be in the form of a coupon which may be an electronic coupon or a coupon that may be printed via a printer to receive merchandise or services either free or at a reduced price.

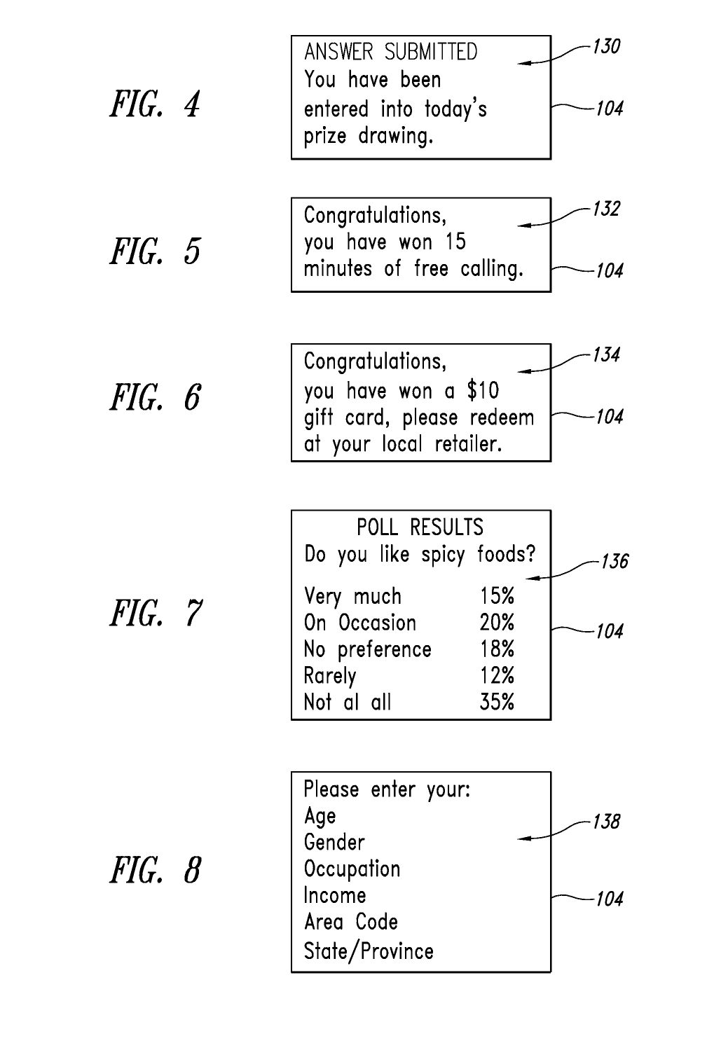

FIG. 5 shows the display 106 of the bidirectional wireless communications device 20 displaying an incentive or reward notification message 132 notifying the user of the award of an incentive or reward. As noted above, provision of an incentive or reward may provide positive motivation for the individuals or users to respond to queries or questions. Such may be limited to entry into a drawing or other mechanism where fewer rewards are provided than entries, or alternatively, such may include automatically awarding an incentive or reward to all users who submit valid responses or answers.

FIG. 6 shows the display 106 of the bidirectional wireless communications device 20 displaying an incentive or reward notification message 134 notifying the user that the user has received an incentive or reward that may be redeemed at a retail location. The message 134 may include redemption information including an address of the retail location and/or a verification identifier such as a serial number to establish at the retail location that the user is entitled to the incentive or reward.

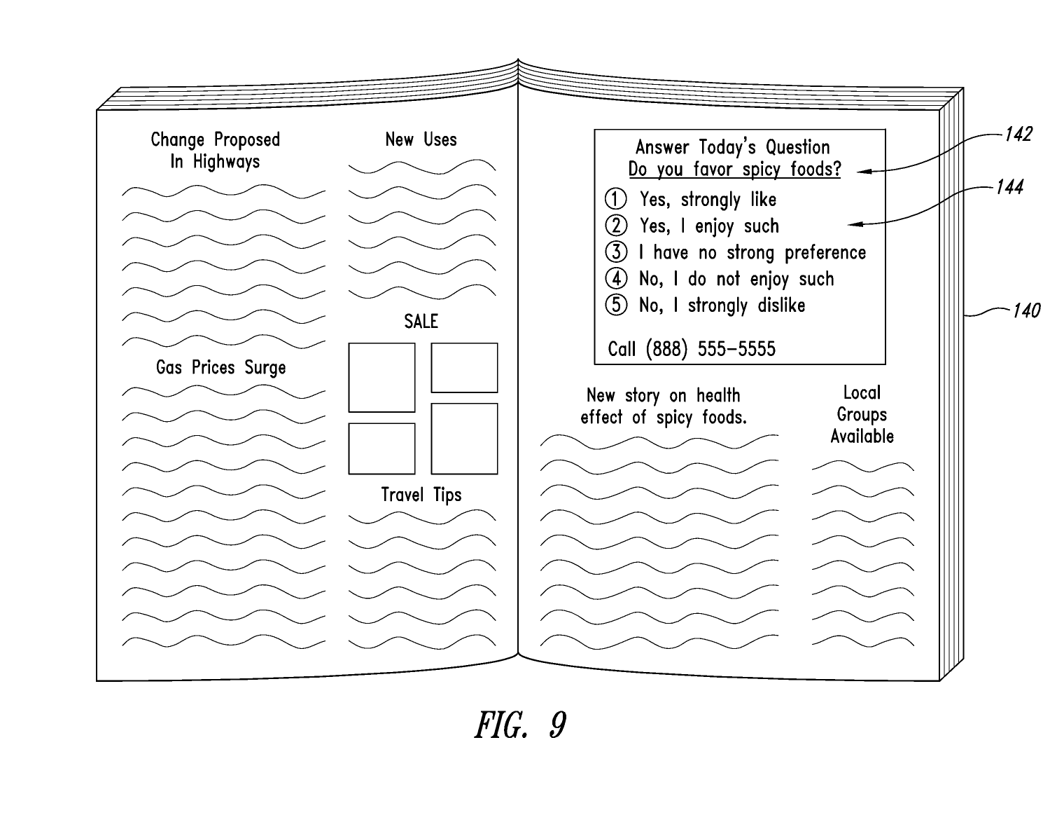

FIG. 7 shows the display 106 of the bidirectional wireless communications device 20 displaying a polling results message 136 that provides results of the polling or analysis thereof. Results may include an indication of the percentage of respondents selecting each of the responses or answers. The results may be broken down using demographic data, for example by geographic region (e.g., country, state, province, city, postal or zip code, area code) associated with the various respondents, and/or age, occupation, income, gender, preferences or purchasing habits of the various respondents. Access to some or all of the results and/or analysis may constitute the incentive or reward for participating in the polling. For example, participation may entitle a user to access all of the results and/or analysis. Alternatively, participation may entitle a user to access a portion of the results and/or analysis, with access to the remainder of the results and/or analysis limited to those willing to pay a fee, for example on a subscription or as needed basis.

FIG. 8 is a schematic view of the display of the wireless communications device of FIG. 3, showing an exemplary respondent demographic inquiry message 138 according to an illustrated embodiment. The message may include a number of demographic queries with input fields for allowing the user to response or answer such demographic queries. Queries may include, but are not limited to: age, occupation, income, gender, preferences, purchasing habits, geographic region of primary residence (e.g., country, state, province, city, postal or zip code, area code.

In some embodiments, the demographic inquiry message 138 may be displayed only once, the first time the user access the polling system 10. The polling computing system 22 associates the demographic information with an identifier associated with the user and/or with wireless communications device 20 employed by the user to submit the demographic information. Such identifiers may, for example, include the International Mobile Subscriber Identity (“IMSI”), the telephone number or Mobile Subscriber ISDN, and/or the International Mobile Equipment Identity (“IMEI”) each defined under the European Global System for Mobile Communications (“GSM”) standard. In other embodiments, the demographic inquiry message 138 may be displayed from time-to-time, periodically or non-periodically.

FIG. 9 shows media in the form of an edition of a periodical 140 such as a journal, newspaper, or magazine presenting a polling question 142 and a set of responses 144. Editions of such media are typically published in a geographically limited areas (city, state, etc.), and one a periodic basis.

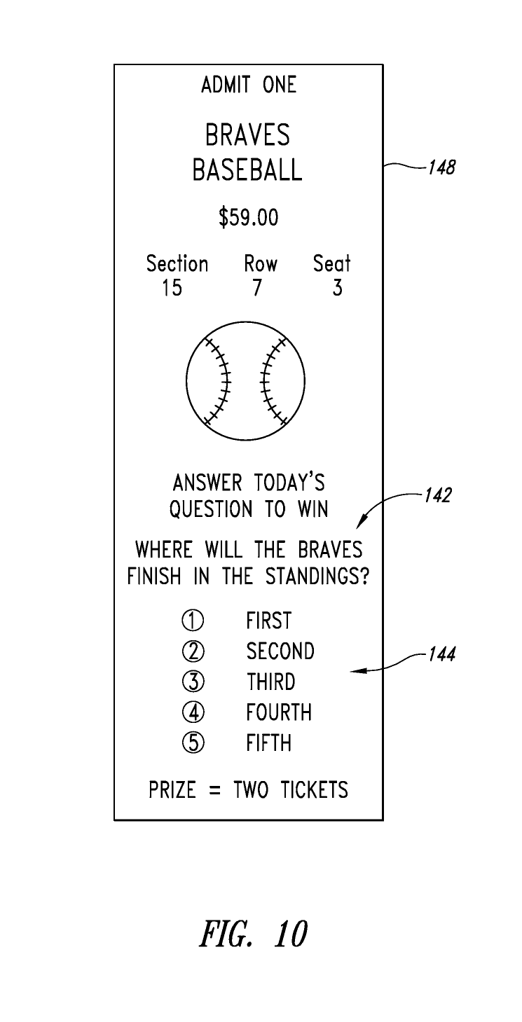

FIG. 10 shows media in the form of an edition of a ticket or pass 148 presenting a polling question 142 and a set of responses 144. A separate edition is typically provided for each game or show. Tickets 148 include tickets to sports or game events, shows, museums, zoos, aquariums, and other venues, as well as lottery or other wagering tickets. The distribution is typically limited to a geographic location proximate the venue.

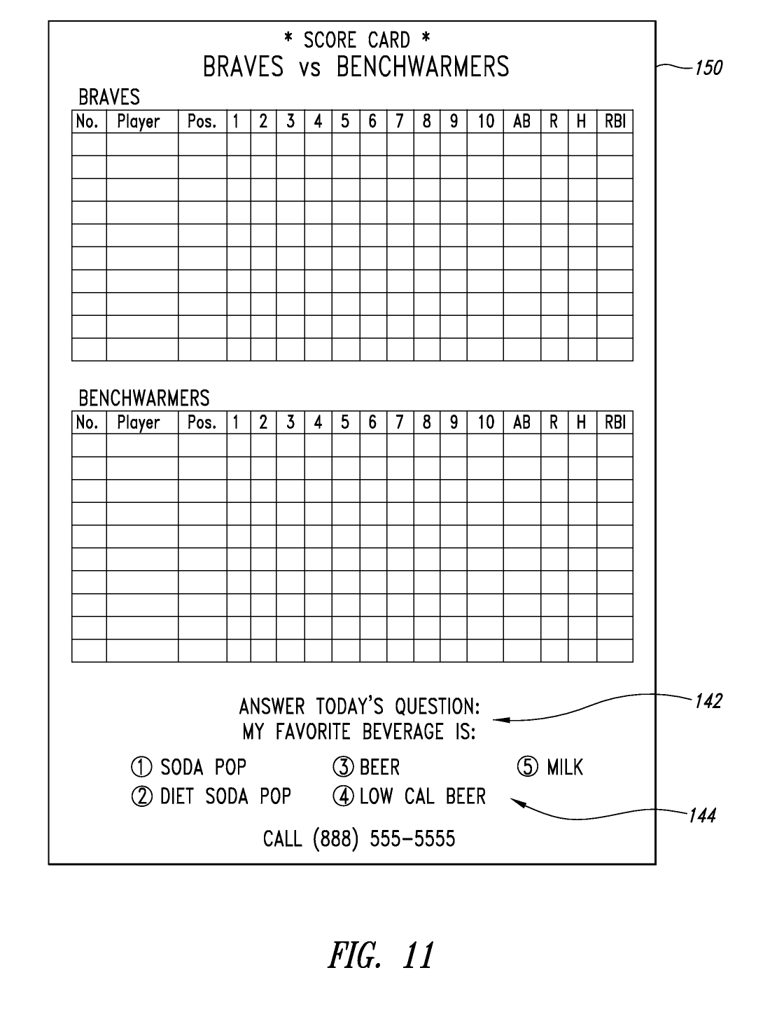

FIG. 11 shows media in the form of an edition of a score card 150 presenting a polling question 142 and a set of responses 144. Such may take the form of a scorecard for baseball, bowling, golf or some other game or sport. A separate edition is typically provided for each game. The distribution is typically limited to a geographic location proximate the venue.

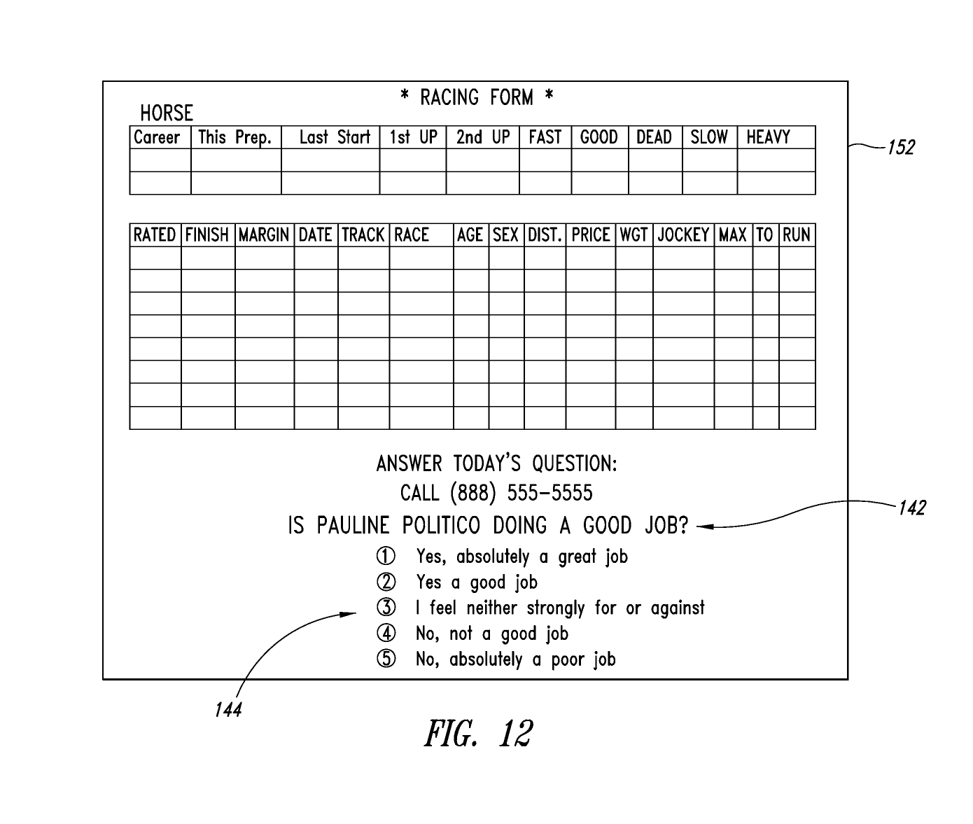

FIG. 12 shows media in the form of an edition of a racing form 152 presenting a polling question 142 and a set of responses 144. A separate edition is typically provided for each day. The distribution is typically limited to a geographic location proximate the track.

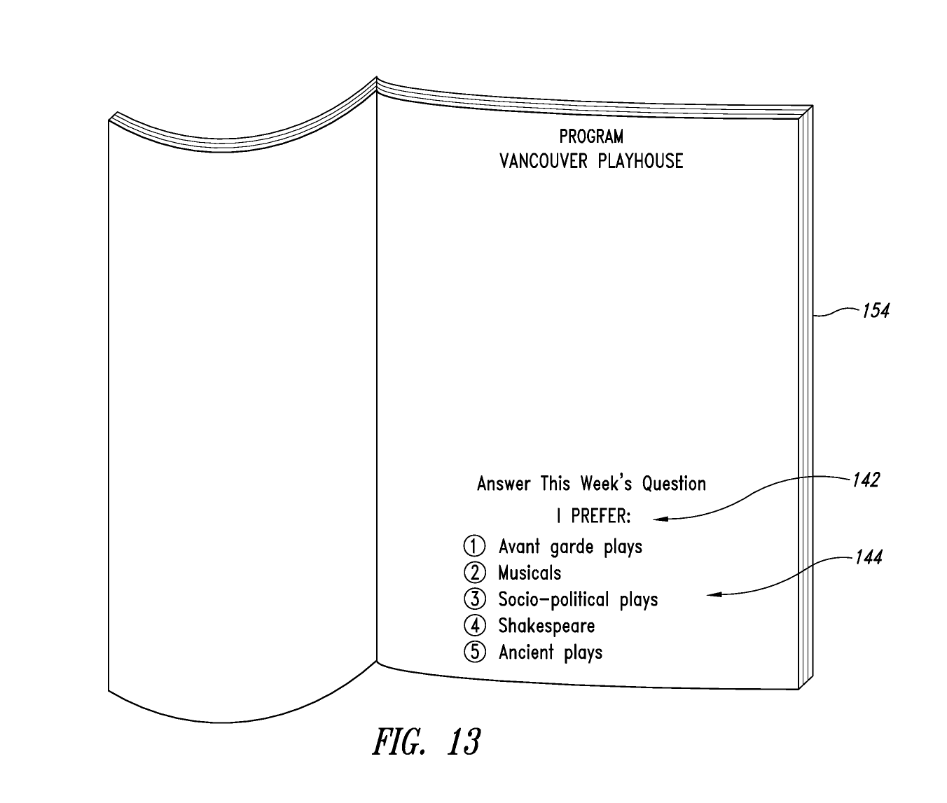

FIG. 13 shows media in the form of an edition of a program or schedule 154 presenting a polling question 142 and a set of responses 144. A separate edition is typically provided for each game, show or event. The distribution is typically limited to a geographic location proximate the venue.

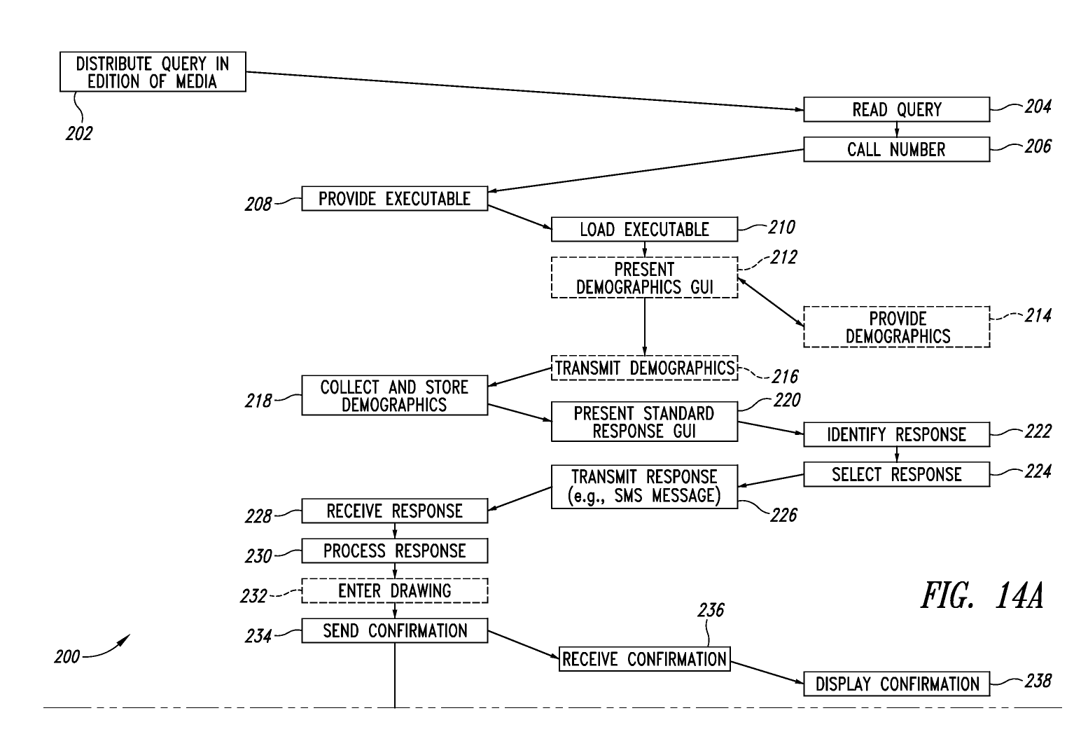

FIGS. 14A and 14B are a high level flow diagram illustrating a method 200 of operation and acts of a publisher (left most column), polling computing system (next column to the right), bidirectional wireless communications device (next column to the right) and user of the bidirectional wireless communications device (right most column), according to one illustrated embodiment.

At 202, the publisher publishes an edition of media. As discussed above, the media may take a variety of forms, including periodical 140 such as a journal, newspaper, or magazine, ticket or pass 148, score card 150, racing form 152, and/or program or schedule 154. The edition is typically has a limited useful life, for example being considered useful or valid until an next edition is published or until an event which the media is associated occurs, for example a show where the media is an admittance ticket for the particular show. Each edition also typically has a geographically limited distribution. Such may be considered a principal target geographic area, for example a local newspaper or tickets for a local concert, even though it is recognized that some appreciable number of copies may be distributed outside the primary distribution area.

Different editions of the media may present different questions and a set number of responses of answers, with appropriate legends to unique identify the responses or answers. Some editions may omit queries, and some editions may repeat queries. For example, a query may be posed in every other edition, or the same query may be posted in each daily edition for a week, the query changing from week to week.

At 204, the user reads the query. At 206, the user calls a number or links to an address provided in the media along with the query.

In response, the polling computing system 22 or some related system provides an executable set of instructions to the bidirectional wireless communications device 20 at 208. At 210, the bidirectional wireless communications device 20 loads and executes the executable set of instructions.

Optionally at 212, the bidirectional wireless communications device 20 presents one or more demographic inquiry messages 138 (FIG. 8). Optionally at 214, the user provides demographic information via the demographic inquiry messages 138. Optionally at 216, the bidirectional wireless communications device 20 transmits the demographic information to the polling computing system 22. At 218, the polling computing system 22 collects and stores demographic information.

While in some embodiments, demographic information regarding geographic location may be derived from responses to a demographic query (e.g., demographic inquiry message 138) provided to the user, in other embodiments the polling computing system 22 may alternatively, or additionally derive the geographic location information automatically. For example, at 218 the polling computing system 22 may automatically collect geographic location information by deriving the geographic location information based on a characteristic of or associated with, the bidirectional wireless communications device 20. For example, the polling computing system 22 may associate the bidirectional wireless communications device 20 with a country code or area code of a telephone number assigned to the device (e.g., Mobile Subscriber ISDN). Alternatively, or additionally, the polling computing system 22 may employ information stored in a database, such as the Home Location Register (“HLR”) and/or a Visitor Location Register (“VLR”) of the wireless service provider. Such information may include a residence or billing address of an entity (e.g., individual, business or association) to which the wireless communications device is assigned or owned. The polling computing system 22 may employ multiple databases, for example determining a name from a first database and a residence address from a second database. Alternatively, or additionally, the polling computing system 22 may employ information regarding a current location of the bidirectional wireless communications device 20. Such may ascertain geographic location to a particular cell 14a-14f, or may more precisely determine the location using techniques employed by wireless service providers for providing location information to fire, police and other first responders. Typically, such more precise location information will not be necessary since the geographic distribution of the media 24a-24k will rarely be so limited.

At 220, under the direction of the executable instructions the bidirectional wireless communications device 20 presents the standard graphical user interface window 118 (FIG. 3). At 222, the user scrolls or otherwise identifies one of the use selectable icons 120a-120e, and at 224 the user selects the identified user selectable icon 120b, for example by clicking. At 226, the bidirectional wireless communications device 20 transmits the response to the polling computing system 22, for example via an SMS message.

At 228, the polling computing system 22 receives the response. At 230 the polling computing system 22 processes the response. For example, the polling computing system 22 may employ date and time information and/or geographical location information to associate the received responses or answers with particular queries, as discussed in more detail below.

Optionally at 232, the polling computing system 22 or some associated system enters the response or respondent into a drawing for an incentive or reward. At 234, the polling computing system 22 sends a confirmation notification message 130 (FIG. 4) to the bidirectional wireless communications device 20, for example via an SMS message. At 236, the bidirectional wireless communications device 20 receives the confirmation notification message 130, and at 238 displays the confirmation notification message 130 to the user.

Optionally at 240, the polling computing system 22 or some associated system determines one or more winners of the drawing. Optionally at 242 the polling computing system 22 or some associated system sends an incentive or reward notification message 132, 134 (FIGS. 5 and 6) to the bidirectional wireless communications device 20, which optionally displays the incentive or reward notification message 132, 134 to the user at 246.

Optionally at 248, the user redeems the incentive or reward. Optionally at 250, the polling computing system 22 or some associated system verifies the redemption of the incentive or reward, for example verifying a unique identifier such as a serial number or automatically providing credit to some account, or access to some restricted Website or the like.

At 252, the polling computing system 22 or some associated system analyzes the responses. For example, the polling computing system 22 may associate, tabulate and/or categorize the received responses or answers to particular queries with demographic information such as geographical location information, occupation, age, gender, personal preferences and/or purchasing habits of the respondents, as discussed in more detail below. At 254, the polling computing system 22 or some associated system provides the results and/or analysis. Such may optionally be provided as an incentive to the bidirectional wireless communication device at 256, which may optionally display the results and/or analysis to the user at 260. Alternatively, or additionally, the results and/or analysis may be provided to others, for example for a fee on a subscription or on an as needed basis.

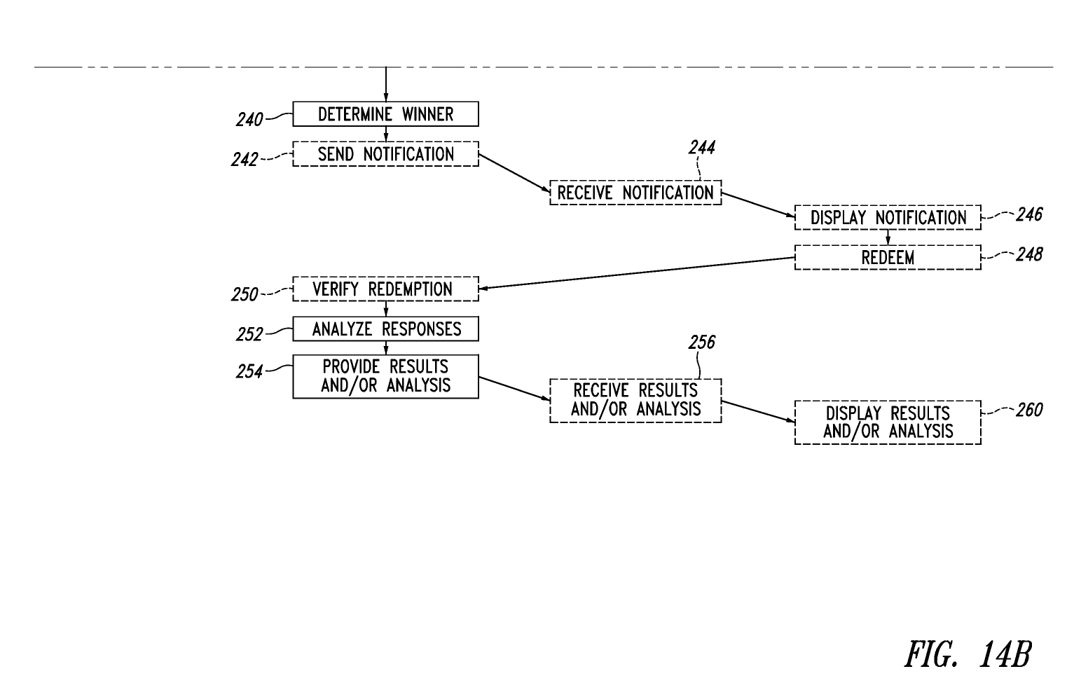

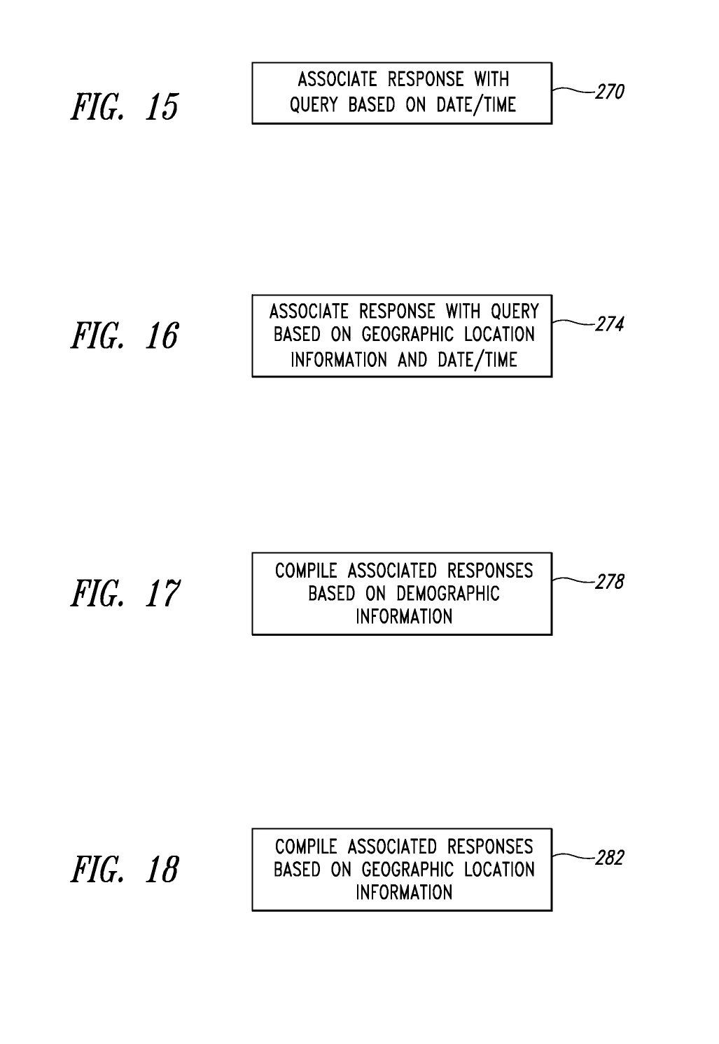

FIG. 15 is a flow diagram illustrating a method of processing responses according to one illustrated embodiment. At 270, the polling computing system 22 or some associated system associates the response with a query based at least in part on date and/or time. The date and/or time of the response may be the date and/or that the response is sent. Such an approach may employ a date stamp placed on the message that transmits the response. Alternatively, or additionally, the date and/or time of the response may be the date and/or time may be the date and/or time the response is received by the polling computing system 22. The date and/or time of the response is compared with a date and/or time of the current edition of the media. Thus, for example an edition of a daily newspaper may be considered current until a new edition is distributed (e.g., 4 AM the next day), or an edition of weekly magazine may be considered current until a new edition is distributed (e.g., Mondays at 9 AM). Also for example, an edition of a ticket, scorecard of program may be considered current until the associated show, game, event is over, or for some set period of time thereafter (e.g., 2 hours). This approach allows responses submitted using a standard interface (e.g., five possible selections) to be associated with various queries appearing in different editions of the media, whether the editions are temporal in nature, geographic in nature or both. For example, a newspaper may not only have different editions each day or even multiple editions in a day, but may also different editions for the same time period in different geographic areas. Thus, there may be separate East Coast and West Coast morning editions published, as well as separate East Coast and West Coast evening editions published.

FIG. 16 is a flow diagram illustrating a method of processing responses according to one illustrated embodiment. At 274, the polling computing system 22 or some associated system associates the response with a query based at least in part on geographic location information. For example, the polling computing system 22 may associate the response to a query appearing in edition of the media distributed in a geographic location associated with the wireless communications device 20, the user or wireless subscriber. As described above, the polling computing system 22 may employ location information supplied by the user, or automatically derived from the wireless communications system. The location information may be based on a current location of the bidirectional wireless communications device 20, the typical location of such a device (e.g., assigned country and/or area code), or the location of the bidirectional wireless communications device 20 user or subscriber (e.g., billing address).

FIG. 17 is a flow diagram illustrating a method of processing responses according to one illustrated embodiment. At 278, the polling computing system 22 or some associated system compiles the associated responses based at least in part on demographic data. Such may compile and otherwise analyze the responses based, for example, on age, gender, income, geographic location, occupation, preferences, purchasing habits, etc.

FIG. 18 is a flow diagram illustrating a method of processing responses according to one illustrated embodiment. At 282, the polling computing system 22 or some associated system complies the associated responses based on geographic location information. As noted above, such geographic location information may be supplied by the user, or automatically derived from the wireless communications system. As further noted above, such geographic location information may be based on a current location of the bidirectional wireless communications device 20, the typical location of such a device (e.g., assigned country and/or area code), or the location of the bidirectional wireless communications device 20 user or subscriber (e.g., billing address).

The above description of illustrated embodiments, including what is described in the Abstract, is not intended to be exhaustive or to limit the invention to the precise forms disclosed. Although specific embodiments of and examples are described herein for illustrative purposes, various equivalent modifications can be made without departing from the spirit and scope of the invention, as will be recognized by those skilled in the relevant art. The teachings provided herein of the invention can be applied to other communications systems not necessarily the exemplary cellular communications system generally described above.

For instance, the user interface of one or more of the wireless communications devices 20 may be voice activated. In such instances, the user may orally issue a first command to identify the desired icon or response (e.g., “scroll left”, “scroll right” or “one”, “two”, “three”, “four” or “five”), and a second command to select the icon or response (e.g., “select”).

Also for instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms of taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including but not limited to U.S. patent application Ser. Nos. 10/072,846, filed Feb. 6, 2002; and 11/134,992, filed May 23, 2005; and U.S. Provisional Patent Application No. 60/723,466, filed Oct. 4, 2005, are incorporated herein by reference, in their entirety. Aspects of the invention can be modified, if necessary, to employ systems, circuits and concepts of the various patents, applications and publications to provide yet further embodiments of the invention.

These and other changes can be made to the invention in light of the above-detailed description. In general, in the following claims, the terms used should not be construed to limit the invention to the specific embodiments disclosed in the specification and the claims, but should be construed to include all systems, methods and articles that accord with the claims. Accordingly, the invention is not limited by the disclosure, but instead its scope is to be determined entirely by the following claims.

1. A method of polling employing bidirectional wireless communications devices operating in a bidirectional wireless communications medium and at least one other media, the method comprising:
presenting a series of queries in at least a first medium different from the bidirectional wireless communications medium;
receiving responses to various ones of the queries at least partially via the bidirectional wireless communications medium; and
computationally associating the received responses with specific ones of the queries.

2. The method of claim 1 wherein computationally associating the received responses with specific ones of the queries comprises associating received responses to specific ones of the queries based at least in part on one of a time of receipt of the response or a time of transmittal of the response.

3. The method of claim 1 wherein computationally associating the received responses with specific ones of the queries comprises associating received responses with the respective one of the queries that appears in a current edition of the first medium.

4. The method of claim 3 wherein computationally associating the received responses with specific ones of the queries further comprises associating each of the received responses to a specific one of at least two queries, each one of the queries appearing in a respective edition of the first medium that is distributed in a respective one of at least two geographically limited areas based at least in part on a geographic area which is associable with respective ones of the received responses.

5. The method of claim 4 wherein associating each of the received responses to a specific one of at least two queries comprises associating the received responses based at least in part on a geographic location of bidirectional wireless communications device when response is sent.

6. The method of claim 4 wherein associating each of the received responses to a specific one of at least two queries comprises associating the received responses based at least in part on a geographic location of an address associated with an owner of the bidirectional wireless communications device.

7. The method of claim 1 wherein presenting a series of queries in at least a first medium comprises presenting the queries in print medium.

8. The method of claim 7 wherein presenting the queries in print medium comprises presenting the queries in a print medium selected from the group consisting of newspapers, magazines, tickets, passes, programs, scorecards, schedules, betting forms and billboards.

9. The method of claim 1 wherein presenting a series of queries in at least a first medium comprises presenting a different one of the queries in each of a number of successive editions of a print medium.

10. The method of claim 9 wherein presenting a different one of the queries in each of a number of successive editions of a print medium comprises presenting a different one of the queries in two successive editions of the print medium with at least one additional edition of the print medium intervening between the two successive editions of the print medium.

11. The method of claim 1 wherein presenting a series of queries in at least a first medium comprises presenting the queries in at least one of a radio medium or a television medium.

12. The method of claim 1 wherein receiving responses to various ones of the queries at least partially via the bidirectional wireless communications medium comprises receiving a plurality of short message service messages originated from a number of cellular phones.

13. The method of claim 1, further comprising:
compiling the received responses based at least in part on a number of geographic areas which are associable with respective ones of the received response.

14. The method of claim 13 wherein compiling the received responses based at least in part on a number of geographic areas which are associable with respective ones of the received response comprises compiling the received responses based at least in part on a geographic location of bidirectional wireless communications device when response is sent.

15. The method of claim 13 wherein compiling the received responses based at least in part on a number of geographic areas which are associable with respective ones of the received response comprises compiling the received responses based at least in part on a geographic location of an address associated with an owner of the bidirectional wireless communications device.

16. The method of claim 1, further comprising:
providing a confirmation of at least some of the received responses to the respective bidirectional wireless communications device from which the responses were received.

17. The method of claim 1, further comprising:
providing a tally of the received responses to at least one of the bidirectional wireless communications devices.

18. The method of claim 1, further comprising:
determining whether at least one of the bidirectional wireless communications device is entitled to an incentive; and
awarding the incentive if the bidirectional wireless communications device is entitled to the incentive.

19. A polling system, comprising:
communications means for receiving responses originated from a plurality of bidirectional wireless communications medium to various ones of a plurality of queries posed in a first medium different from a bidirectional wireless communications medium employed by the bidirectional wireless communications devices; and
computational means for computationally associating the received responses with specific ones of the queries.

20. The polling system of claim 19 wherein the computational means comprises means for associating received responses to specific ones of the queries based at least in part on one of a time of receipt of the response or a time of transmittal of the response.

21. The polling system of claim 19 wherein the computational means comprises means for associating received responses with the respective one of the queries that appears in a current edition of the first medium

22. The polling system a of claim 19 wherein the computational means comprises means for associating the received responses based at least in part on a geographic location of bidirectional wireless communications device when response is sent.

23. The polling system of claim 19, further comprising:
means for automatically compiling the received responses based at least in part on a number of geographic areas which are associable with respective ones of the received response comprises compiling the received responses based at least in part on a geographic location of bidirectional wireless communications device when response is sent.

24. The polling system of claim 19, further comprising:
means for automatically compiling the received responses based at least in part on a number of geographic areas which are associable with respective ones of the received response comprises compiling the received responses based at least in part on a geographic location of an address associated with an owner of the bidirectional wireless communications device.

25. A processor-readable medium storing instructions to cause a processor to implement a user interface for polling on a bidirectional wireless communications device, by:
in response to repeated user inputs over time of a first user input type, repeatedly displaying a set of icons on a display of the bidirectional wireless communications device, a quantity of icons in the set of icons being equal to a quantity of responses in each of a plurality of sets of responses to a respective query of a plurality of queries and all of the icons in the set of icons being displayed each time, the queries and the sets of responses posed in a form of media different from a bidirectional wireless form of media employed by the bidirectional wireless communications device, and the icons being displayed without displaying of the queries or specific ones of the responses on the display of the bidirectional wireless communications device, the icons being user identifiable and user selectable icons;
determining whether a user input is an icon identifying input or an icon selection input; and
transmitting a wireless message from the bidirectional wireless communications device that includes an indication of the selected one of the set of icons in response to a determination that that the user input is the icon selection input.

26. The processor-readable medium of claim 25 wherein determining whether a user input is an icon identifying input or an icon selection input comprises determining whether the user input is a scrolling type of user input or a clicking type of user input.

27. The processor-readable medium of claim 25 wherein determining whether a user input is an icon identifying input or an icon selection input comprises determining whether the user input is a rocker action of a joystick or a clicking action of the joystick.

28. The processor-readable medium of claim 25, wherein instructions to cause a processor to implement a user interface for polling on a bidirectional wireless communications device further comprise:
providing an indication in a response to a query of when the response to the query is sent.

29. The processor-readable medium of claim 28 wherein providing an indication in a response to a query of when the response to the query is sent comprises providing an indication of a date and time of day.
